(19) United States
(12) Patent Application Publication
(10) Pub. No.: US 2013/0286226 A1
(43) Pub. Date: Oct. 31, 2013

(54) MODULAR PERIPHERAL DIGITAL CAMERA SYSTEM CONNECTABLE TO PORTABLE COMPUTING DEVICES

(71) Applicant: EXO LABS, INC., Bellevue, WA (US)

(72) Inventors: Michael Baum, Bellevue, WA (US); Jeffrey Stewart, Seattle, WA (US)

(73) Assignee: EXO LABS, INC., Bellevue, WA (US)

(21) Appl. No.: 13/787,336

(22) Filed: Mar. 6, 2013

Related U.S. Application Data
(60) Provisional application No. 61/639,622, filed on Apr. 27, 2012.

(51) Int. Cl. G06F 3/00; H04N 5/225

(52) U.S. Cl. CPC G06F 3/005; H04N 5/2254
USPC 348/207.1

(57) ABSTRACT

A modular imager or camera system is selectively communicatively coupleable to a portable computing device. The camera system may include interchangeable lenses, and coupling structure to physically removably couple to other device, for instance microscopes. The camera system may also have the capability to connect, receive input from, or provide output to one or more input devices or output devices, which may be connected either in addition to or in place of an image sensor. The portable computing device may run one or more apps which receive and/or process images or other data from the camera system, control the camera system, and/or share images and other information between multiple portable computing devices and/or camera systems. Such is particularly useful in educational settings, allowing students or groups of students to operate respective camera systems and share images, for example under control of a teacher or facilitator.

### BACKGROUND

1. Technical Field

This disclosure is related to image capture and image capture devices.

2. Description of the Related Art

The ability to capture digital images/video using portable computing devices is highly desirable. However, digital cameras that are often built into portable devices are limited in their functionality and modularity.

According to the U.S. Federal Communications Commission (FCC) Code of Federal Regulations (CFR) Title 47 Part 2.1093(b), a portable device is defined as “a transmitting device designed to be used so that the radiating structure(s) of the device is/are within 20 centimeters of the body of the user.” Additionally, portable computing devices exclusively rely on a wireless communications connection (as opposed to a physical/cabled connection) to facilitate communication functionality with other devices and communication networks. Common computing devices such as most laptop personal computers, desktop personal computers, and other computing terminals are not considered portable devices by this definition.

Portable computing devices such as smartphones, internet-connected multimedia devices, and tablet computers have powerful computing capabilities and are able to provide much of the functionality previously possible only with non-portable computing devices such as those described above. Most portable computing devices are also able to provide additional useful functionality such as real-time communication and data collection, and many of these devices have integrated camera and lens assemblies able to capture still digital images and video images as well.

Peripheral digital camera systems connectable to non-portable computing devices are already commercially available to consumers. Some of these devices provide specialized functionality by utilizing high magnification optical systems, integrated light sources, or modular light guide caps. Examples include those proposed in U.S. Pat. No. 4,930,951 to Mitsubishi Kasei Co., et al. (1990), and U.S. Pat. No. 5,442,489 to Scalar Co. et al. (1995). A similar product, “Handheld Digital and Optical Microscope Item #44306” was a peripheral digital camera system produced by Celestron, LLC. Similarly, several peripheral camera products provided by Scalar Co. and Ken-A-Vision Mfg. Co., Inc. have also been made available for purchase.

A peripheral microscope camera connectable to portable terminals is proposed in U.S. patent application 2011/0085032 to LG Innotek Co., Ltd. (2011). This device is specifically designed for use as a microscope camera.

Furthermore, many portable computing devices are able to capture, store, retrieve, share, annotate, and edit images and/or video collaboratively with other computing devices and output devices, as proposed in U.S. patent application 2010/0333194 to C. Ricordi, S. Sikes, S. Sanders, N. Tsinoremas (2009). The ability of portable computing devices to communicate with accessory devices using wireless communication methods has also been detailed in U.S. patent application 2010/023552 to Apple Inc. (2010).

### BRIEF SUMMARY

Most if not all existing peripheral digital camera systems which applicants are aware of are unable to connect to portable computing devices, are not able to attach modular lenses, are not able to mount to standard microscopes, are not able to provide illumination to imaging subjects, do not provide digital input/output (I/O) interfaces to their accessories, and/or are not able to simultaneously charge the battery packs of either or both the peripheral camera system and the portable computing device.

The peripheral microscope camera described above, does not contain a battery power source in the camera module, and does not provide for modular lens attachment. Thus, this device is also limited in its functionality.

Digital cameras integrated into portable computing devices heretofore known, peripheral digital cameras connectable to non-portable computing devices heretofore known, and digital cameras connectable to portable terminals heretofore known suffer from one or more of the following disadvantages.

(a) The position of cameras built into portable computing devices is usually fixed or limited, requiring users to reposition the entire portable computing device when aiming the camera, thus negatively impacting user ability to access or interact with the portable computing device controls and output.

(b) The ability to mount, constrain, or environmentally isolate cameras built into portable computing devices is limited by the physical size, shape, mass, and configuration of the portable computing device.

(c) Optical characteristics such as image resolution, field of view, focal length, optical filtering characteristics, and target illumination are limited by the size, optics, and physical configuration of the portable computing device.

(d) The ability to capture images or video over long periods of time is limited by the battery capacity of the connected portable computing device.

(e) The ability to simultaneously charge the battery packs of either or both the peripheral camera system and the portable computing device while capturing images or video is not provided.

(f) The ability to control, send data to, and receive data from accessories attached to peripheral camera systems via a digital input/output (I/O) interface is not provided.

(g) The ability to capture, store, retrieve, share, annotate, control, and edit images, video, and/or data with other portable computing devices and accessories, while also displaying images, video, and/or processed information on external viewing devices, is limited by the availability of secondary or tertiary wireless communication modules in the interconnected devices and accessories.

(g) The ability to remotely control or interact with other portable computing devices and accessories, while also displaying images, video, and/or processed information on external viewing devices, is limited by the availability of secondary or tertiary wireless communication modules in the interconnected devices and accessories.

(h) The ability to connect, receive input from, or provide output to one or more input devices or output devices (e.g., sensors, actuators, control systems, annunciators, display devices, etc.), either in addition to or in place of an image sensor.

### BRIEF DESCRIPTION OF THE SEVERAL VIEWS OF THE DRAWINGS

In the drawings, identical reference numbers with different alphabetic suffixes identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1a is a schematic view of a modular peripheral digital camera system connectable to portable computing devices via wired electrical connection according to an exemplary embodiment of the present disclosure;

FIG. 1b is a schematic view of a modular peripheral digital camera system connectable to portable computing devices via wireless electromagnetic communication system according to another exemplary embodiment of the present disclosure;

FIG. 1c is a schematic view of a modular peripheral digital camera system connectable to portable computing devices via wired electrical connection, used with a viewing instrument, according to an exemplary embodiment of the present disclosure;

FIG. 1d is a schematic view of a modular peripheral digital camera system connectable to portable computing devices via wireless electromagnetic communication system, used with a viewing instrument, according to another exemplary embodiment of the present disclosure;

FIG. 2a is a side elevation section view schematically illustrating the camera module subassembly shown in FIGS. 1a and 1c according to an exemplary embodiment of the present disclosure;

FIG. 2b is a side elevation section view schematically illustrating the wireless camera module subassembly shown in FIGS. 1b and 1d according to another exemplary embodiment of the present disclosure;

FIGS. 3a-3d are block diagrams illustrating the camera module control system configuration contained in the camera module subassembly shown in FIGS. 1a-1d according to exemplary embodiments of the present disclosure;

FIGS. 4a-4d are side elevation section views schematically illustrating the modular lens accessory subassembly shown in FIGS. 1a and 1b according to exemplary embodiments of the present disclosure;

FIGS. 5a-5b are flowcharts illustrating operation of the modular peripheral digital camera system connectable to portable computing devices shown in FIGS. 1a-1d according to exemplary embodiments of the present disclosure;

FIGS. 6a-6c, 7a-7c, 8a-8c, and 9a-9c are diagrams illustrating interconnected operation of the modular peripheral digital camera system connectable to portable computing devices according to exemplary embodiments of the present disclosure.

### DETAILED DESCRIPTION

In the following description, certain specific details are set forth in order to provide a thorough understanding of various disclosed embodiments.

However, one skilled in the relevant art will recognize that embodiments may be practiced without one or more of these specific details, or with other methods, components, materials, etc. In other instances, well-known structures associated with digital cameras or image capture devices, associated lighting systems, and/or portable computing devices have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

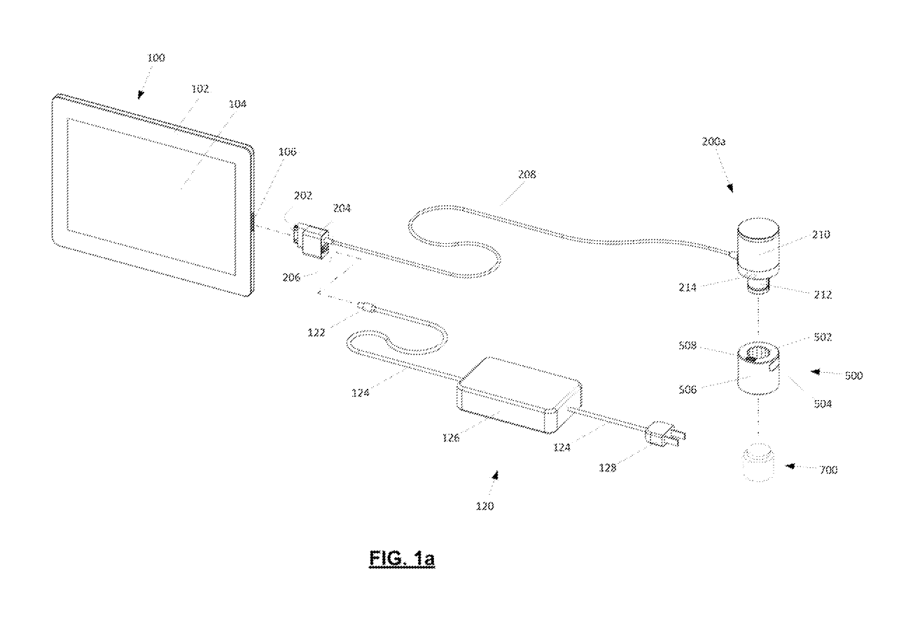

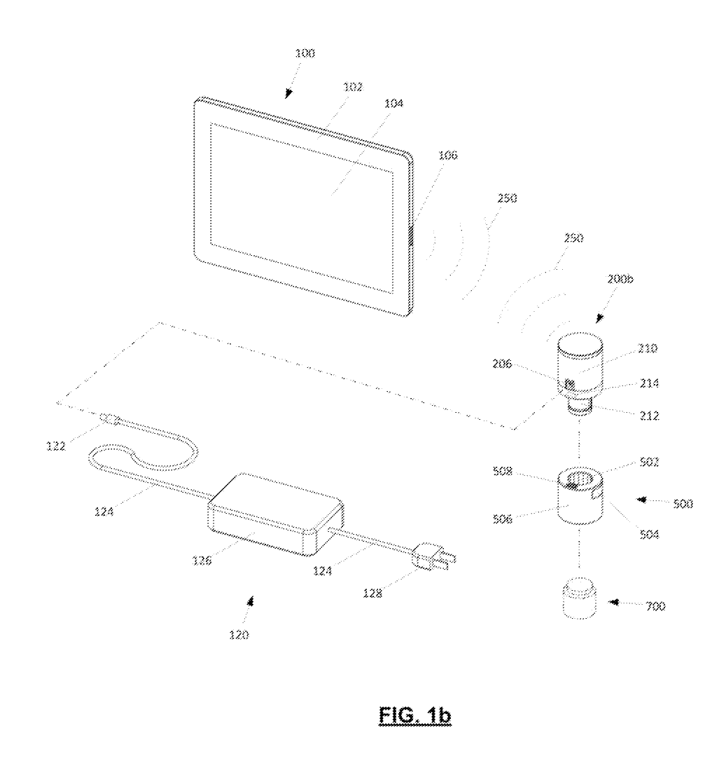

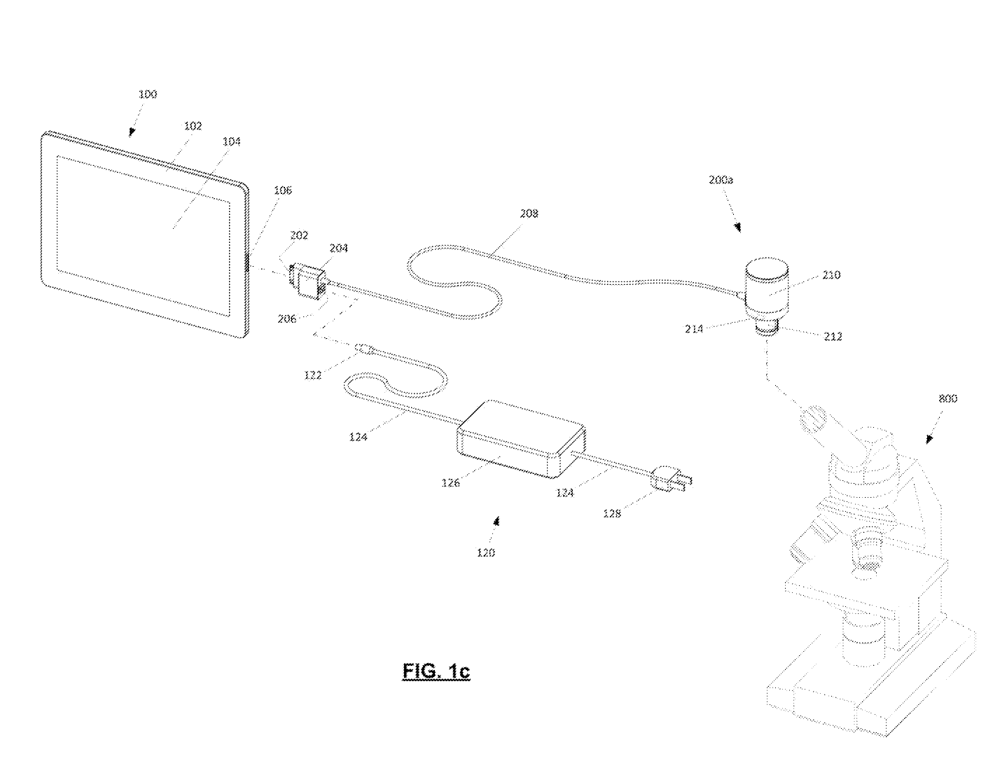

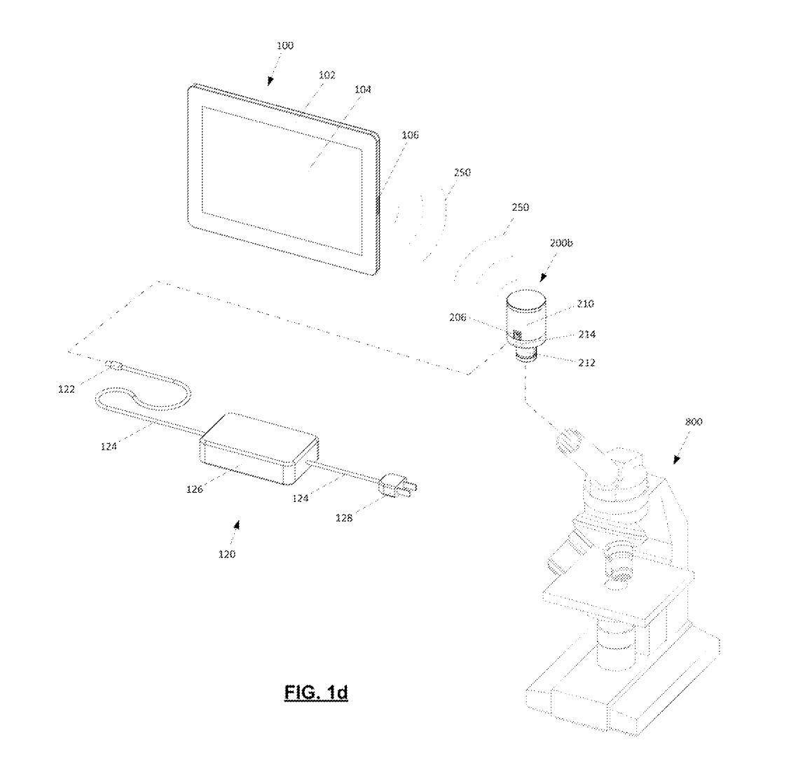

Referring to FIG. 1a, a portable computing device 100 may be communicatively connected or coupled to a camera module subassembly 200a which may be physically coupled or attached to a modular lens accessory subassembly 500 which may in turn be physically coupled or attached to a lens unit 700. An external power supply 120 may also be electrically coupled or connected to camera module subassembly 200a to provide continuous electrical power or battery charging capability as needed.

Portable computing device 100 may include a body 102, a display unit 104, and a power/data connector, receptacle or port 106.

Body 102 which is a housing forming an external area of the portable computing device 100 may include at least one of an electrical energy storage system (e.g., chemical secondary battery cells), a wireless communication module, a memory module, a microprocessor, an input device (e.g., a pushbutton, a capacitive touch sensor, a switch, etc.), a camera, a microphone, a speaker, an indicator device (e.g., a light emitting diode, a vibrating motor, an actuator, etc.), an audio input/output connector, a position sensing device (e.g., a global positioning system, an electronic compass, an altimeter, etc.), and an environmental sensing device (e.g., a proximity sensor, a thermometer, multi-axis accelerometer, etc.).

The display unit 104 may include at least one of an LCD (Liquid Crystal Display), a TFT-LCD (Thin Film Transistor Liquid Crystal) display, an OLED (Organic Light Emitting Diode) display, an AMOLED (Active Matrix Organic Light Emitting Diode) display, an electronic ink display, an EWD (Electro-Wetting Display, a VFD (Vacuum Fluorescent Display), and a 3D (3 Dimensional) display.

The power/data receptacle 106 may include at least one electrical connection point for a power connection, an audio input connection, an audio output connection, a video input connection, a video output connection, a signal line input connection, and a signal line output connection.

The external power supply 120 may include a DC (Direct Current) power connector 122, body 102, a power cable 124, a power supply 126, and an AC (Alternating Current) power plug 128.

External power supply 120 may include at least one electrochemical cell (e.g., battery) that stores electrical energy, able to provide suitable continuous electrical power to camera module subassembly 200a as needed. One or more electrical batteries housed within external power supply 120 may be removable, replaceable, or rechargeable (i.e., secondary battery) via electricity supplied through power cable 124 or by other means.

The DC power connector 122 will provide DC electrical power and electrical ground connections to power supply 126 through power cable 124, which may include several individually-insulated electrically conductive wires bundled within another electrically insulative sheath. Power supply 126 includes a housing which may be constructed of or may include electrically insulative materials. Also, power supply 126 will include electrical components (e.g., passive or active rectifier, transformer, buck converter, filters) that convert AC electrical power to DC electrical power at a desired voltage range and electrical current range. Power plug 128 is an electrical connector which may include at least one electrical plug or receptacle that can connect with AC mains or standard residential power. Although power plug 128 is shown as a two-pronged male plug, this configuration is just an example and not limited thereto. It should be apparent to those skilled in the art that various standardized AC electrical connectors may be used for power plug 128.

The camera module subassembly 200a is a device which may include a power/data connector 202, a power/data connector housing 204, a DC power receptacle 206, a power/data cable 208, a camera module housing 210, a camera module accessory adapter 212, and an accessory receptacle 214.

Power/data connector 202 is an electrical connector which may include several electrically-connected contacts having a shape and mating pattern opposite yet matching that of power/data receptacle 106. Similarly, DC power receptacle 206 is an electrical connector which may include several electrically-connected contacts having a shape and mating pattern opposite yet matching that of DC power connector 122. Both power/data connector 202 and DC power receptacle 206 are partially enclosed within power/data connector housing 204, which may be constructed of or may include electrically insulative materials.

The power/data cable 208 may include several individually-insulated electrically conductive wires bundled within another electrically insulative sheath. In some embodiments, power/data cable 208 may include several individually-insulated electrically conductive wires bundled within an electrically conductive sheath, which is then bundled within another electrically insulative sheath.

The camera module housing 210 is a rigid structure which supports and protects functional electronic components within camera module subassembly 200a, and is rigidly attached to camera module accessory adapter 212. The camera module accessory adapter 212 may be a structure with a downward-facing open end. The main rigid body of camera module accessory adapter 212 configured to loosely fit within the inner shape of typical viewing instrument (e.g., microscope) eyepiece sockets. While not limited to such, the structure may in some implementations have a partially cylindrical shape. While not limited to such, the main rigid body of camera module accessory adapter 212 may in some implementations have a diameter of less than 23 mm.

The accessory receptacle 214 is an electrical connector which may include at least one electrical connection point for a power connection, an audio input connection, an audio output connection, a signal line input connection, and a signal line output connection. Accessory receptacle 214 may be positioned so as to not protrude below the lower structural surface of camera module housing 204. In other exemplary embodiments, accessory receptacle 214 may have the capability to connect, receive input from, or provide output to one or more input devices or output devices (e.g., sensors, actuators, control systems, annunciators, display devices, etc.). In some exemplary embodiments, one or more input devices or output devices (e.g., sensors, actuators, control systems, annunciators, display devices, etc.) may be connected either in addition to or in place of an image sensor within camera module subassembly 200a or wireless camera module subassembly 200b.

According to the exemplary embodiment of FIG. 1a, the modular lens accessory subassembly 500 is a device which may include a modular lens accessory socket 502, a modular lens accessory latch 504, a modular lens accessory housing 506, and a modular lens accessory connector 508.

The modular lens accessory socket 502 may be a rigid structure which has a shape which may be opposite yet matching (i.e., complementary) the shape of camera module accessory adapter 212. Additionally, modular lens accessory socket 502 is typically greater than 23 mm in diameter, to allow camera module accessory adapter 212 to loosely fit within its inner shape. Additionally, modular lens accessory socket 502 may have a shape or protruding alignment structure that ensures that camera module accessory adapter 212 will be oriented in a certain direction as it engages or disengages with modular lens accessory socket 502.

The modular lens accessory latch 504 may be a spring-loaded or flexibly held component which may hold camera module subassembly 200a in a fixed position relative to modular lens accessory subassembly 500 when camera module accessory adapter 212 is slidably engaged with modular lens accessory socket 502. When actuated (e.g., by a pushing motion, a pulling motion, a sliding motion, etc.), modular lens accessory latch 504 may also disengage camera module subassembly 200a from its fixed position relative to modular lens accessory subassembly 500. Thus, the camera module subassembly 200a is detachably coupled to the modular lens accessory subassembly 500.

The modular lens accessory housing 506 may be a rigid structure which supports and protects functional components within modular lens accessory subassembly 500. Additionally, an opening may be provided in modular lens accessory housing 506 allowing modular lens accessory connector 508 to protrude through.

The modular lens accessory connector 508 is an electrical connector which may include several electrically-connected contacts having a shape and mating pattern opposite yet matching (i.e., complementary) one or more of the mating electrical contacts of accessory receptacle 214. When held in a fixed position relative to modular lens accessory subassembly 500 by modular lens accessory latch 504, camera module subassembly 200a may provide electrical signals and power to modular lens accessory subassembly 500 via one or more electrical connection between modular lens accessory connector 508 and accessory receptacle 214.

The lens unit 700 is a device which may include at least one self-contained housing encasing at least one axially-aligned optical lens for enlarging, reducing, focusing, or modifying the view of an optical image. Additionally, the lens unit 700 may be a commercially available standardized lens unit having a threaded end for attachment. In other exemplary embodiments, lens unit 700 may be attached directly to camera module subassembly 200a or wireless camera module subassembly 200b.

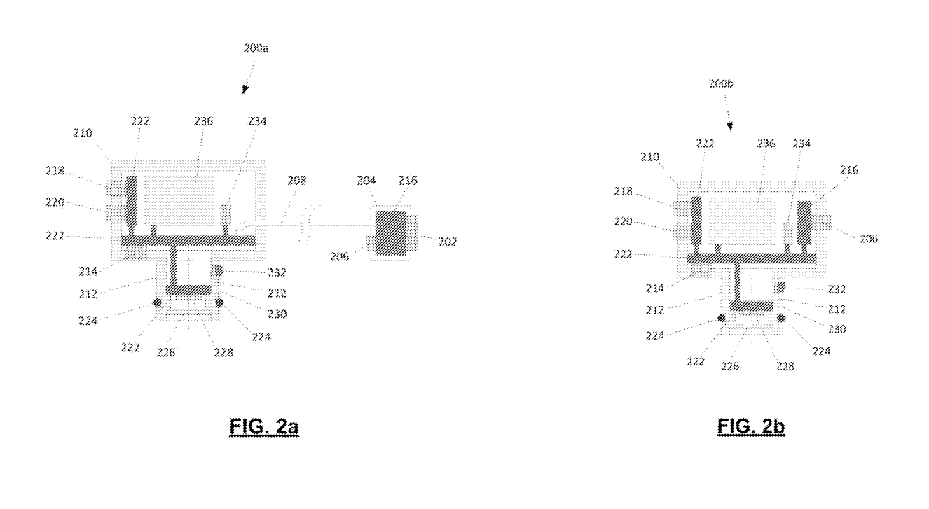

Referring to FIG. 2a, a power controller 216 may include a Printed Circuit Board (PCB) to which power/data connector 202, DC power receptacle 206, and power/data cable 208 may be attached. Additionally, power controller 216 may include electronic components which manage the supply and distribution of power to portable computing device 100 and camera module subassembly 200a. Furthermore, power controller 216 may be housed within power/data connector housing 204.

A camera input device 218 may include at least one input device (e.g., a pushbutton, a capacitive touch sensor, a switch, a microphone, etc.) accessible from outside camera module housing 210.

A camera annunciator 220 may include at least one annunciator device (e.g., a light emitting diode, a visual display, a speaker, etc.) whose status of operation may be easily detectible from outside camera module housing 210.

A camera module control system 222 may include at least one PCB which may be divided into several interconnected sections, and to which functional electronic components of camera module subassembly 200a are attached and connected. Functional components of camera module subassembly 200a may include accessory receptacle 214, an image sensor 228, a wireless module 234, a battery pack 236, power/data cable 208, camera input device 218, and camera annunciator 220.

The image sensor 228 may be a CMOS (Complementary Metal Oxide Semiconductor, a CCD (Charge Coupled Device), or a microbolometer image sensor which converts optical images into electrical data. Image sensor 228 may be mounted to camera module control system 222 oriented with the downward-facing open end of camera module accessory adapter 212.

The wireless module 234 may include at least one electronic subsystem (e.g., radio, transceiver, transmitter, receiver and associated antenna(s)) capable of wirelessly transmitting (e.g., broadcasting) and/or receiving signals through free space via electromagnetic waves. In some exemplary embodiments of the present disclosure, wireless module 234 may be capable of operating under at least one common wireless protocol standard, which may be a WLAN (Wireless Local Area Network) standard, a Bluetooth standard, and a NFC (Near Field Communication) standard.

The battery pack 236 may include at least one electrochemical cell that stores electrical energy, and may be an alkaline battery, a lead-acid battery, a nickel-cadmium battery, a nickel metal hydride battery, a lithium ion battery, and a lithium ion polymer battery. Other power sources may be employed, for example an array of ultra-capacitors or fuel cells.

A gasket 224 is circumferentially attached to camera module accessory adapter 212 to facilitate stable attachment to modular lens accessory subassembly 500, and prevent light leakage when mated with modular lens accessory socket 502. Gasket 224 may be manufactured out of an elastomeric material or flexible shape to conform against mating shapes and surfaces.

An optical window 226 is fixed in place and perpendicularly oriented on the downward-facing open end of camera module accessory adapter 212. The optical window 226 may be a highly optically transparent component manufactured out of a polymeric or a glass material. Additionally, optical window 226 may have a coating which reflects and/or interrupts the transmission of infra-red light.

An alignment channel 230 may include at least one alignment structure protruding inwardly or outwardly along the axial direction of camera module accessory adapter 212. The alignment channel 230 may serve as a guide for alignment and attachment of modular lens accessory subassembly 500. A latch tongue 232 may be oriented along alignment channel 230, and may be a spring-loaded or flexibly held component having a limited degree of motion, designed to engage with mating features in modular lens accessory subassembly 500.

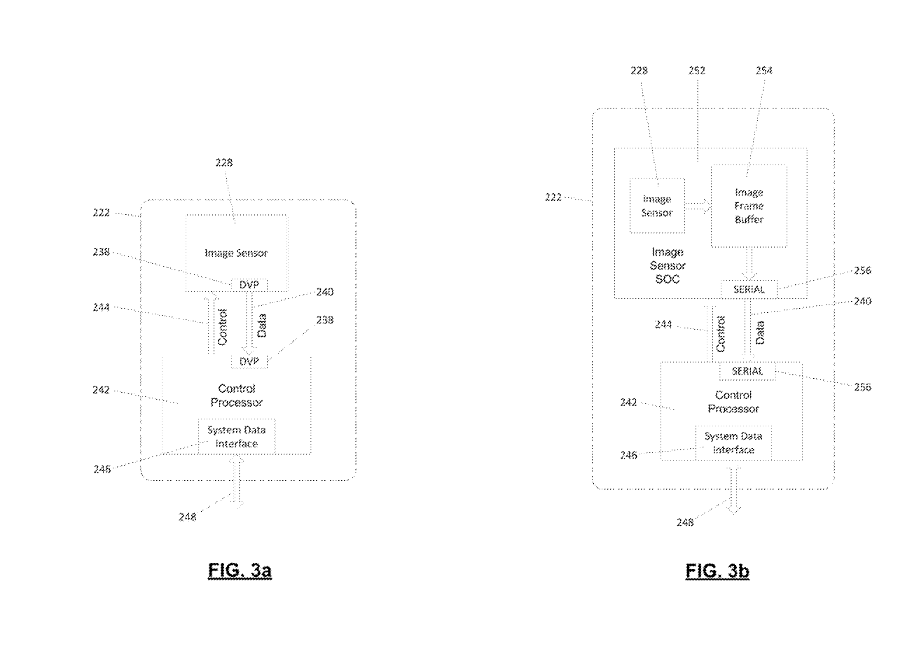

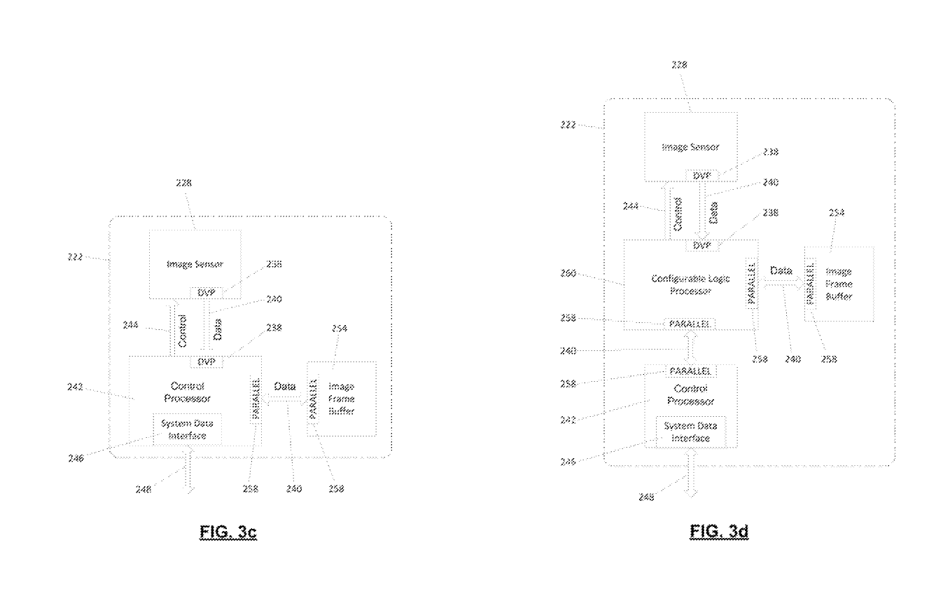

Referring to FIG. 3a, camera module control system 222 may include the image sensor 228 which may use an interface (e.g. DVP (Digital Video Port) interface 238) to transmit an image data stream 240 to complementary interface (e.g., DVP interface 238) that may reside within one or more control processor units 242 (e.g., microprocessor, digital signal processor, application specific integrated circuit, programmable gate array, programmed logic controller). Control processor unit 242 may deliver an image control signal stream 244 to image sensor 228, and may pass the image data stream 240 through to a system data interface 246 while also managing an input/output data stream 248. The input/output data stream 248 receives command signals from, and transmits data to, portable computing device 100.

The DVP interface 238 may be a single-direction or bi-directional communication physical interface specifically configured for digital video data signal communication.

Additionally, but not shown in FIG. 3a, camera module control system 222 may be directly connected to other functional electronic components which may include the accessory receptacle 214, the wireless module 234, the battery pack 236, the power/data cable 208, the camera input device 218, and the camera annunciator 220.

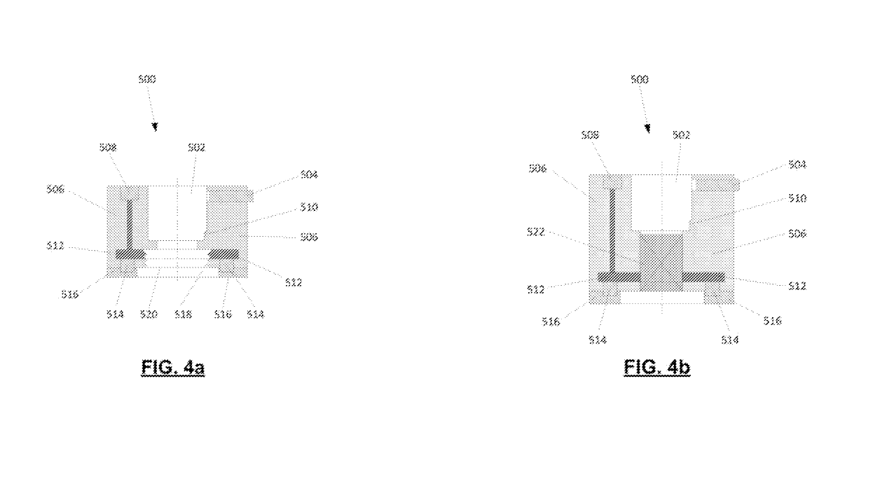

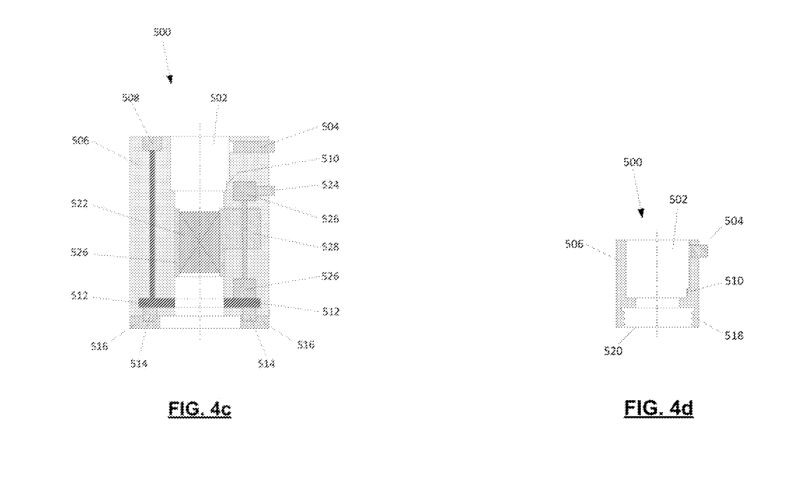

Referring to FIG. 4a, the modular lens accessory subassembly 500 may include the modular lens accessory socket 502, the modular lens accessory latch 504, the modular lens accessory housing 506, and the modular lens accessory connector 508 previously described in FIG. 1a. An alignment key 510 may have a mating yet opposite surface profile to that of alignment channel 230 on camera module accessory adapter 212; the position of alignment key 510 ensures that latch tongue 232 will be appropriately aligned with modular lens accessory latch 504 when modular lens accessory subassembly 500 is fully engaged with camera module subassembly 200a.

A modular lens accessory control system 512 may include at least one PCB which may be divided into several interconnected sections, and to which functional electronic components of modular lens accessory subassembly 500 are attached and connected. Functional components of modular lens accessory subassembly 500 may include modular lens accessory connector 508 and an illumination system 514. The illumination system 514 may include at least one LED (light emitting diode) situated behind a light guide 516.

The light guide 516 may be a partially or highly optically transparent component manufactured out of a polymeric (e.g., acrylic) or a glass material. Additionally, the light guide 516 may have a coating and/or semi-opaque additive which reflects, directs, and/or interrupts the transmission of certain wavelengths of light.

A lens mounting thread 518 is axially aligned with modular lens accessory socket 502 in modular lens accessory housing 506. The lens mounting thread 518 provides a holding or securement feature or structure for attaching lens unit 700. Additionally, the centerline of lens mounting thread 518 is perpendicular to a lens mounting surface 520, which may include at least one downward-facing flat surface providing a physical reference surface for alignment and attachment of lens unit 700.

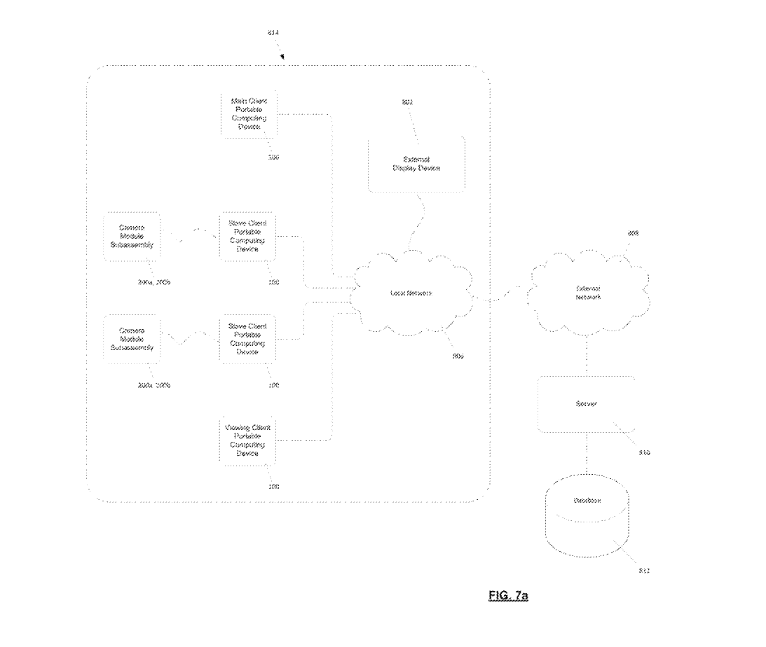

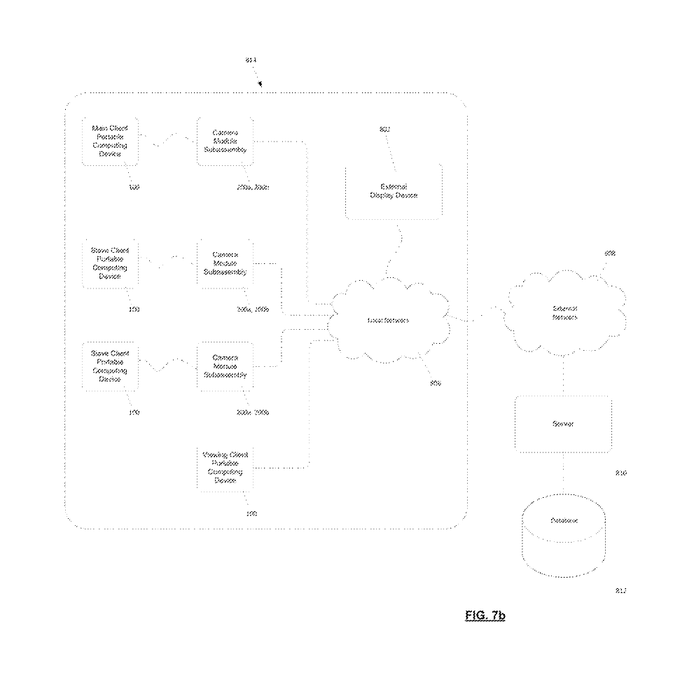

Referring to FIG. 6a, an external display device 802 may be an output device which electronically displays visible images (e.g., a television, a projector, a monitor, etc.), and may be physically or wirelessly connected to a local network 806, which may be an communications network able to interconnect devices with electronic communication capability (e.g., portable computing devices, telecommunication devices, computing terminals, display devices, storage devices, input devices, output devices, etc.).

A local installation 814 may be a set of devices physically and/or wirelessly communicatively interconnected within close proximity (e.g., within one room, within one building, within one organizational area, etc.). According to the exemplary embodiment of FIG. 6a, one portable computing device 100 may act as a main client providing control signals and communication signals to and from one or more portable computing devices 100, which act as slave clients (i.e., devices which receive control signals and/or communication signals from a main client and/or slave clients), or as viewing clients (i.e., devices which receive communication signals from a main client and/or slave clients). The portable computing devices 100 may each be physically or wirelessly communicatively connected or coupled individually to camera module subassembly 200a or to wireless camera module subassembly 200b.

Referring to FIGS. 6b-6c, the external display device 802 may be physically or wirelessly communicatively connected or coupled to the local network 806, within the local installation 814. One portable computing device 100 may act as a main client providing control signals and communication signals to and from one or more portable computing devices 100 which act as slave clients, or to one or more portable computing devices 100 acting as viewing clients. The portable computing devices 100 may each be physically or wirelessly communicatively connected or coupled individually to camera module subassembly 200a or to wireless camera module subassembly 200b. Additionally, local network 806 may be communicatively connected or wirelessly coupled to one or more camera module subassembly 200a, to wireless camera module subassembly 200b, and/or to portable computing device 100. According to the exemplary embodiment of FIG. 6c, the portable computing device 100 acting as the main client may not be communicatively connected to camera module subassembly 200a or to wireless camera module subassembly 200b.

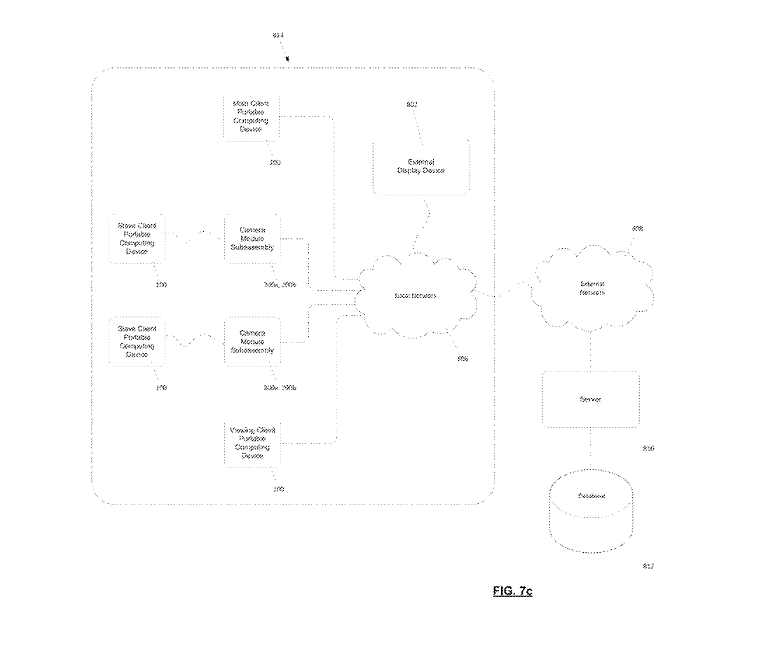

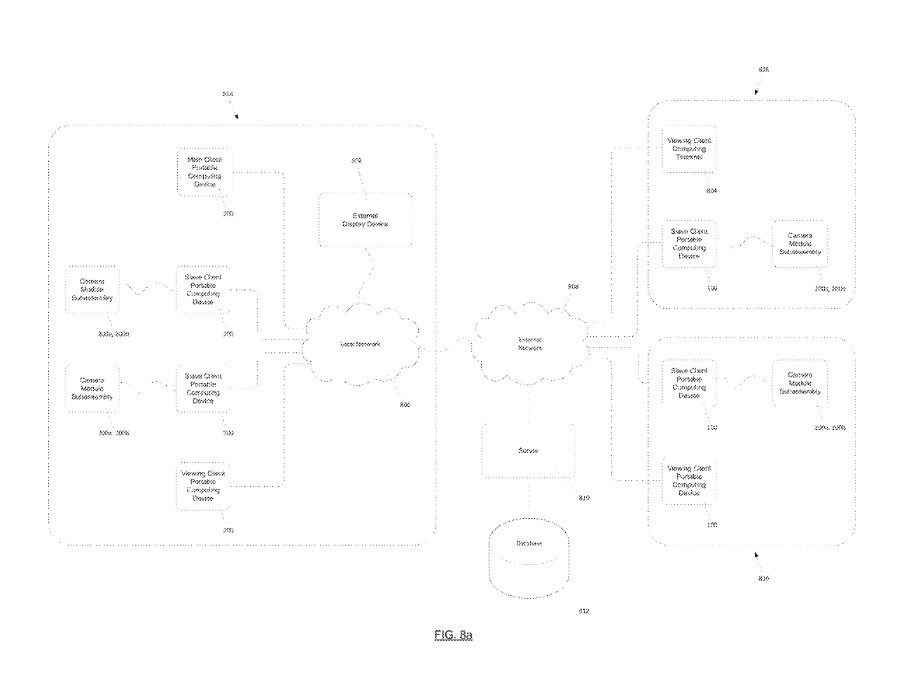

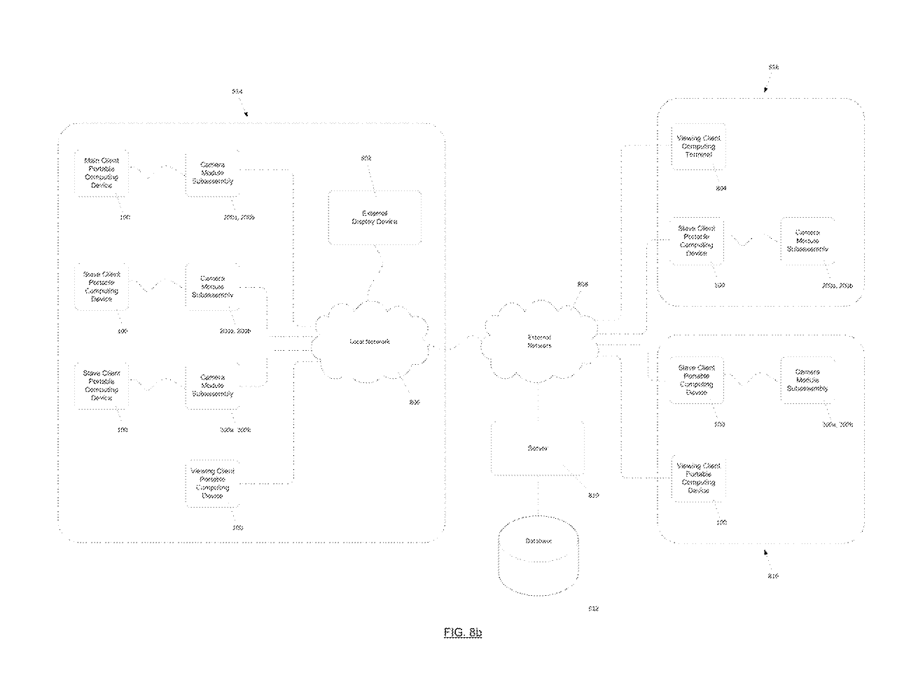

Referring to FIG. 7a, the external display device 802 may be physically or wirelessly connected to the local network 806, within the local installation 814. One portable computing device 100 may act as a main client providing control signals and communication signals to and from one or more portable computing devices 100, which act as slave clients, or as viewing clients. The portable computing devices 100 may each be physically or wirelessly communicatively coupled individually to camera module subassembly 200a or to wireless camera module subassembly 200b. Additionally, local network 806 may be connected physically and/or wirelessly to an external network 808, which may be located externally to the local installation 814. Communicatively coupled to the external network 808 may be at least one of a server 810 which may house or be connected to at least one of a database 812. The server 810 may be a computer program serving the computational and/or communication requests of devices communicatively connected directly or coupled indirectly to external network 808. The database 812 may be one or more organized collections of digitized data.

Referring to FIGS. 7b-7c, the external display device 802 may be physically or wirelessly communicatively connected or coupled to the local network 806, within the local installation 814. One portable computing device 100 may act as a main client providing control signals and communication signals to and from one or more portable computing devices 100 which act as slave clients, or to one or more portable computing devices 100 acting as viewing clients. The portable computing devices 100 may each be physically or wirelessly communicatively connected or coupled individually to camera module subassembly 200a or to wireless camera module subassembly 200b. Local network 806 may be communicatively connected or coupled wirelessly to one or more camera module subassembly 200a, to wireless camera module subassembly 200b, and/or to portable computing device 100. Additionally, local network 806 may be communicatively connected or coupled physically and/or wirelessly to external network 808, which may be located externally to the local installation 814. Communicatively connected or coupled to the external network 808 may be at least one server 810 which may house or be communicatively connected or coupled to at least one database 812. According to the exemplary embodiment of FIG. 7c, the portable computing device 100 acting as the main client may not be communicatively connected or coupled to camera module subassembly 200a or to wireless camera module subassembly 200b.

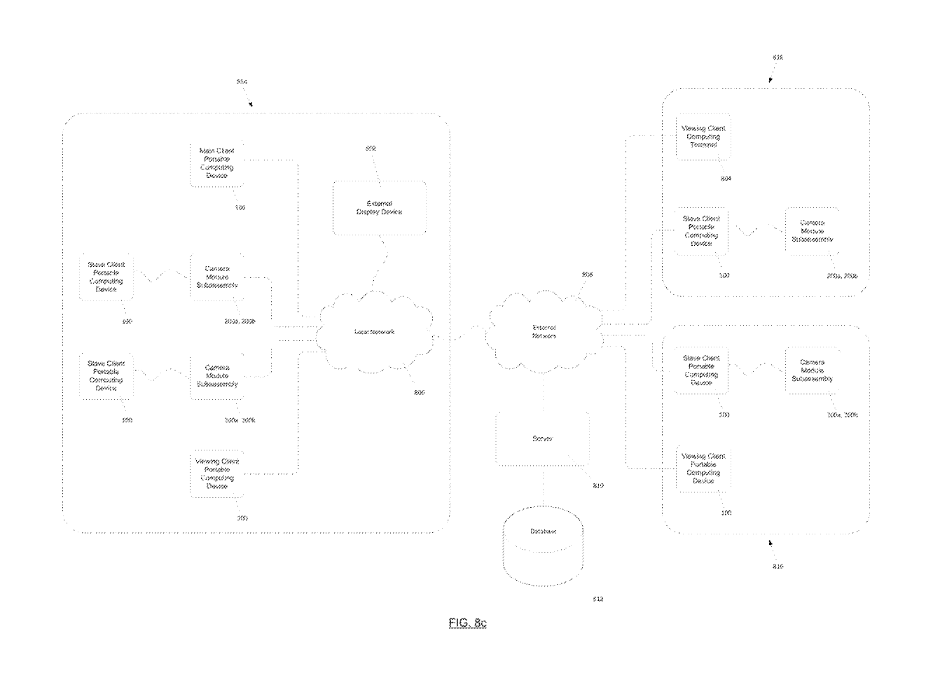

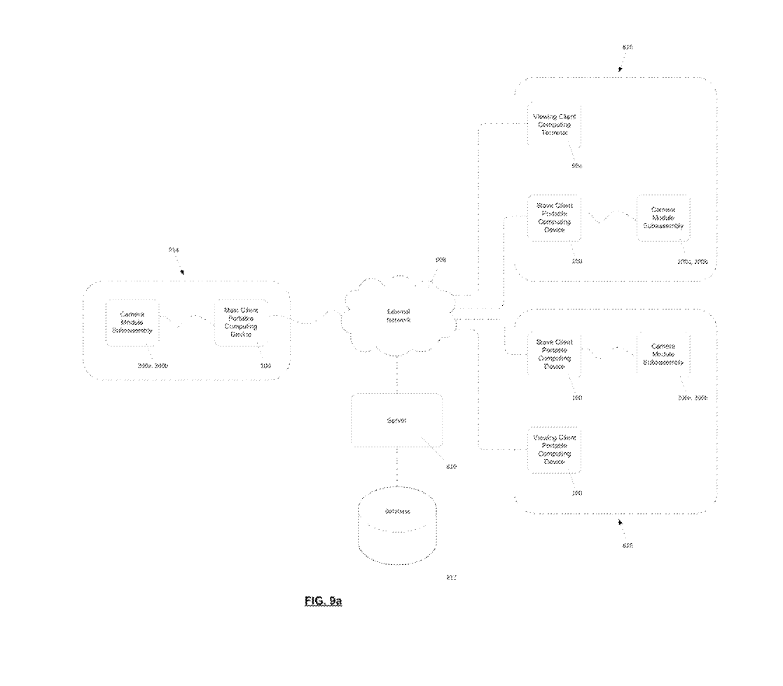

Referring to FIG. 8a, the external display device 802 may be physically or wirelessly communicatively connected or coupled to the local network 806, within the local installation 814. One portable computing device 100 may act as a main client providing control signals and communication signals to and from one or more portable computing devices 100, which act as slave clients, or as viewing clients. Within local installation 814, the portable computing devices 100 may each be physically or wirelessly communicatively connected or coupled individually to camera module subassembly 200a or to wireless camera module subassembly 200b. Local network 806 may be communicatively connected or coupled physically and/or wirelessly to the external network 808, which may be located externally to the local installation 814. Communicatively connected or coupled to the external network 808 may be at least one server 810 which may house or be communicatively connected or coupled to at least one database 812. Additionally, one or more of a distant installation 816 may be communicatively connected or coupled physically and/or wirelessly to the external network 808. The distant installation 816 may be a set of devices physically and/or wirelessly interconnected within close proximity (e.g., within one room, within one building, within one organizational area, etc.), but located separately from local installation 814. Within the distant installation 816, one or more of a computing terminal 804, portable computing device 100, camera module subassembly 200a, and/or wireless camera module subassembly 200b, may be communicatively connected or coupled physically and/or wirelessly. The computing terminal 804 may be a programmable device (e.g., a digital computer, a communication device, and/or a display device) having the ability to display information and communicate via a physical and/or wireless communication data link.

Referring to FIGS. 8b-8c, the external display device 802 may be physically or wirelessly communicatively connected or coupled to the local network 806, within the local installation 814. One portable computing device 100 may act as a main client providing control signals and communication signals to and from one or more portable computing devices 100 which act as slave clients, or to one or more portable computing devices 100 acting as viewing clients. The portable computing devices 100 may each be physically or wirelessly communicatively connected or coupled individually to camera module subassembly 200a or to wireless camera module subassembly 200b. Local network 806 may be communicatively connected or coupled wirelessly to one or more camera module subassembly 200a, or to wireless camera module subassembly 200b. The local network 806 may be communicatively connected or coupled physically and/or wirelessly to external network 808, which may be located externally to the local installation 814. Communicatively connected or coupled to the external network 808 may be at least one server 810 which may house or be communicatively connected or coupled to at least one database 812. One or more distant installation 816 may be communicatively connected or coupled physically and/or wirelessly to the external network 808. Within the distant installation 816, one or more of a computing terminal 804, portable computing device 100, camera module subassembly 200a, and/or wireless camera module subassembly 200b, may be communicatively connected or coupled physically and/or wirelessly. According to the exemplary embodiment of FIG. 8c, the portable computing device 100 acting as the main client may not be connected to camera module subassembly 200a or to wireless camera module subassembly 200b.

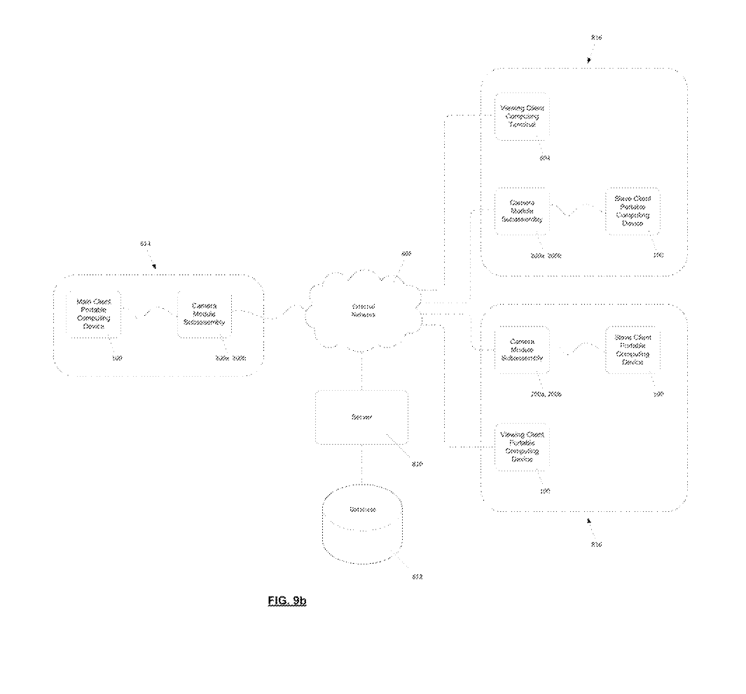

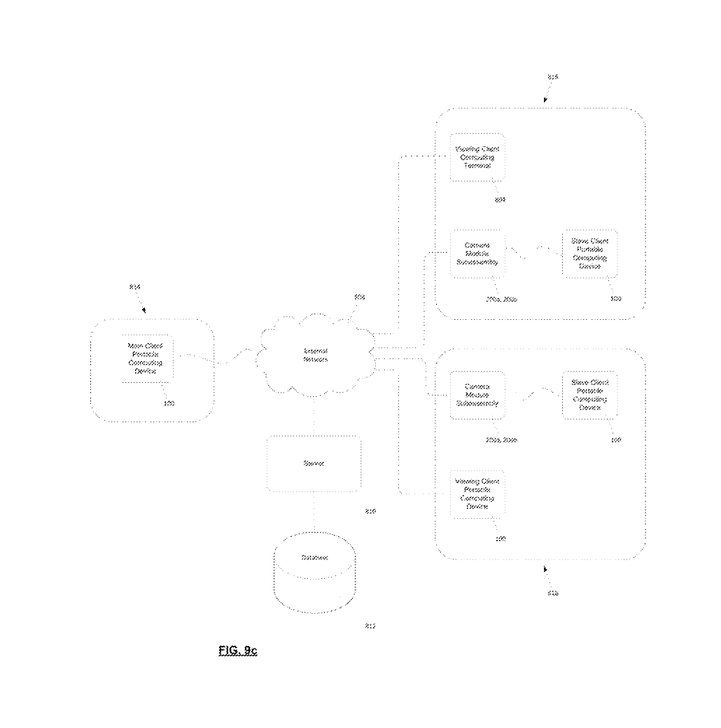

According to the exemplary embodiment of FIG. 9a, the portable computing device 100, within the local installation 814, may be physically or wirelessly communicatively connected or coupled individually to camera module subassembly 200a or to wireless camera module subassembly 200b. This portable computing device 100 within the local installation 814 may act as a main client providing control signals and communication signals to and from one or more slave portable computing devices 100, and/or computing terminal 804, contained within one or more distant installation 816, communicatively connected or coupled via one or more external network 808. Additionally or alternatively, this portable computing device 100 within the local installation 814 may act as a main client providing communication signals to and from one or more viewing clients such as portable computing devices 100, and/or computing terminal 804, contained within one or more distant installation 816, communicatively connected or coupled via one or more external network 808. One or more server 810 may be communicatively connected or coupled to one or more database 812, as well as one or more external network 808. Within each within the distant installation 816, each portable computing device may be physically or wirelessly communicatively connected or coupled individually to camera module subassembly 200a or to wireless camera module subassembly 200b.

According to the exemplary embodiment of FIGS. 9b-9c, the portable computing device 100, within the local installation 814, may be physically or wirelessly communicatively connected or coupled individually to camera module subassembly 200a or to wireless camera module subassembly 200b. This portable computing device 100 within the local installation 814 may act as a main client providing control signals and communication signals to and from one or more slave portable computing devices 100, and/or computing terminal 804, contained within one or more distant installation 816, communicatively connected or coupled via one or more external network 808. Additionally or alternatively, this portable computing device 100 within the local installation 814 may act as a main client providing communication signals to and from one or more viewing clients such as portable computing devices 100, and/or computing terminal 804, contained within one or more distant installation 816, communicatively connected or coupled via one or more external network 808. One or more server 810 may be communicatively connected or coupled to one or more database 812, as well as one or more external network 808. Within each within the distant installation 816, each portable computing device may be physically or wirelessly communicatively connected or coupled individually to camera module subassembly 200a or to wireless camera module subassembly 200b. Communication links between external network 808 and portable computing devices 100 may be facilitated by the wireless communication link of interconnected devices such as camera module subassembly 200a or to wireless camera module subassembly 200b. According to the exemplary embodiment of FIG. 9c, the portable computing device 100 acting as the main client may not be communicatively connected or coupled to camera module subassembly 200a or to wireless camera module subassembly 200b.

### OPERATION—FIRST EMBODIMENT—FIGS. 1a, 2a, 3a, 4a, 5a

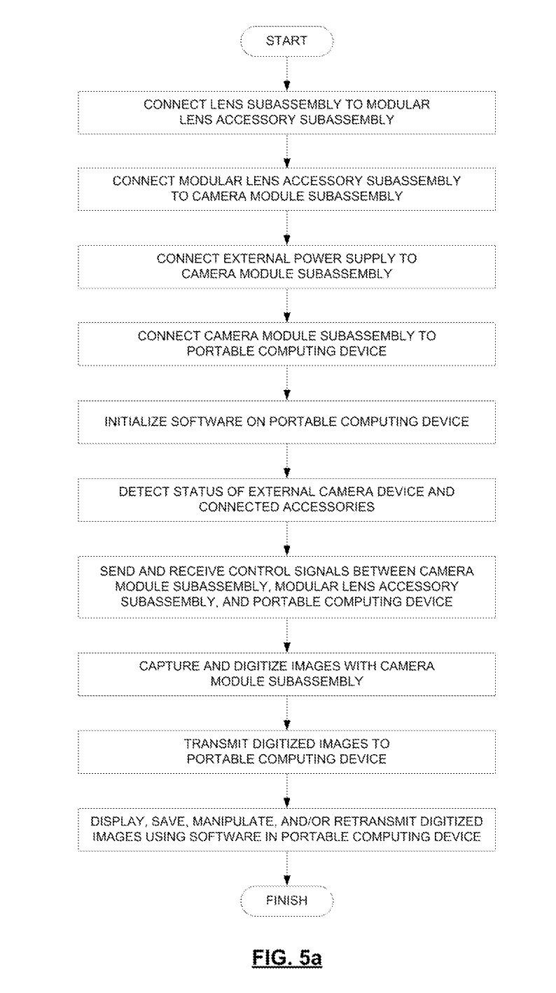

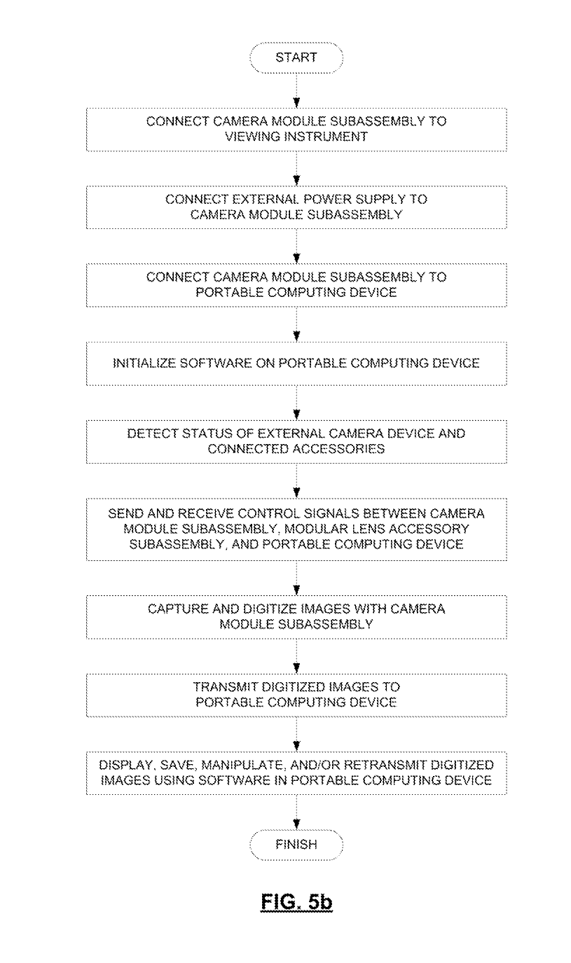

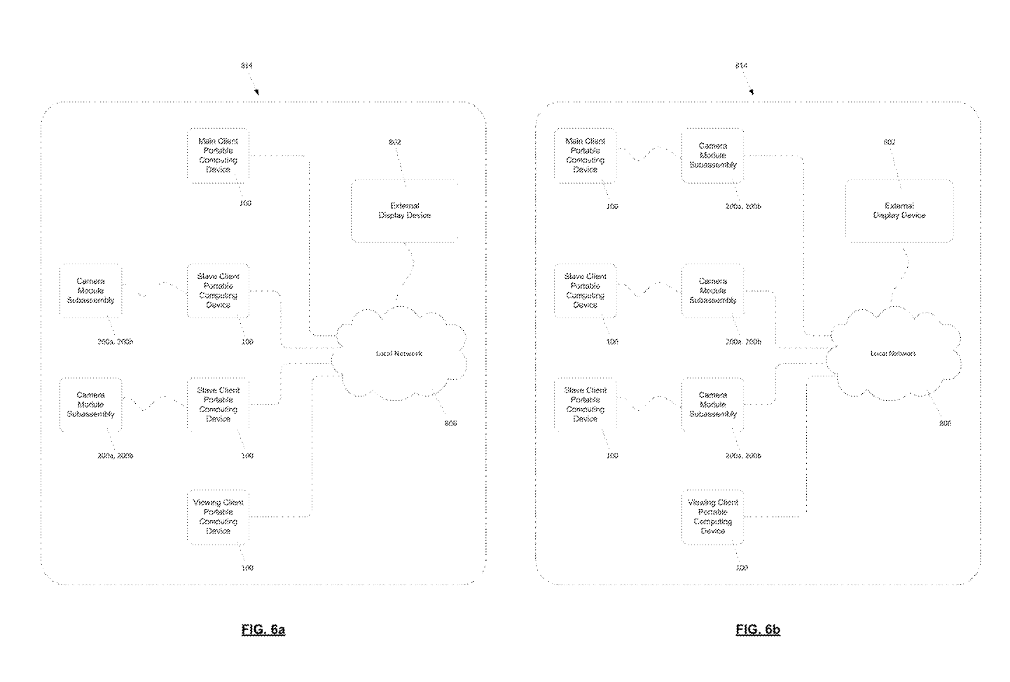

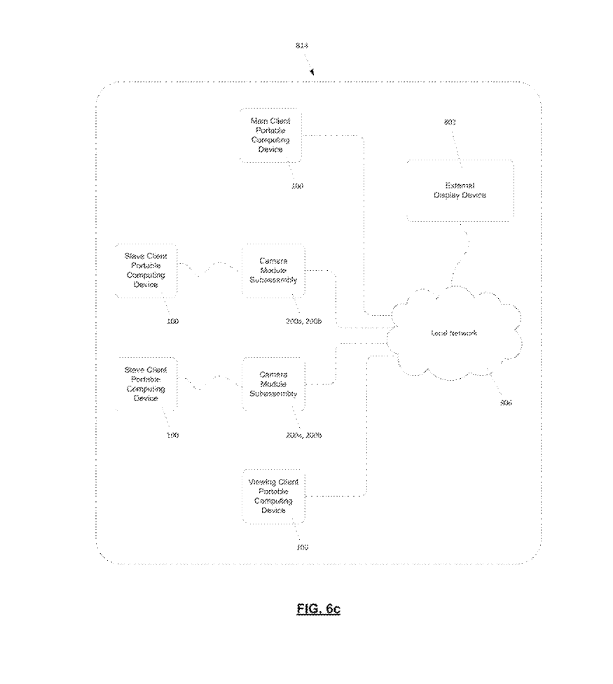

Referring to FIGS. 1a, 2a, 3a, 4a, and the flowchart in FIG. 5a, operation of the first exemplary embodiment of the present disclosure may be as follows.

The lens unit 700 may be connected to modular lens accessory subassembly 500 via lens mounting thread 518.

Modular lens accessory subassembly 500 may then be removably physically connected or coupled to camera module subassembly 200a by inserting camera module accessory adapter 212 into modular lens accessory socket 502, while orienting alignment channel 230 with alignment key 510. Upon full insertion of camera module accessory adapter 212 into modular lens accessory socket 502, latch tongue 232 will engage with modular lens accessory latch 504, preventing camera module subassembly 200a from disengaging with modular lens accessory subassembly 500. Additionally, engagement of alignment channel 230 with alignment key 510 and engagement of latch tongue 232 with modular lens accessory latch 504 provide repeatable alignment and electrical engagement between accessory receptacle 214 and modular lens accessory connector 508. Engagement of accessory receptacle 214 and modular lens accessory connector 508 allows power to be supplied and communication to occur between camera module control system 222 and modular lens accessory control system 512. With power and communication signals supplied to modular lens accessory control system 512, illumination system 514 may be turned ON, turned OFF, or controlled in its level of illumination.

External power supply 120 may then be removably electrically connected or coupled to camera module subassembly 200a by engaging DC power connector 122 into DC power receptacle 206. In the event that external power supply 120 is also connected to mains electrical power via power plug 128, the battery within portable computing device 100 as well as the battery pack 236 may be charged. Given a sufficient battery charge level of the battery within portable computing device 100 and/or of the battery pack 236, portable computing device 100 and/or camera module subassembly 200a will remain operational without connection of external power supply 120.

One may then initialize a software application resident within the memory of portable computing device in order to communicate with, send data to, and receive data from camera module control system 222. Upon initialization of an appropriate software application on portable computing device 100, the status of camera module subassembly 200a and the connected modular lens accessory subassembly 500 may be determined via a communication link provided by the electrical connections carried by power/data cable 208. Possible detectable states or conditions may include at least one of being attached or detected, not being attached or detected, being ready or operational, not being ready or operational, being an approved device, not being an approved device, having an insufficient battery charge, having a modular lens accessory subassembly attached or detected, not having a modular lens accessory subassembly attached or detected, etc.

Upon the appropriate establishment of status of camera module subassembly 200a and of modular lens accessory subassembly 500, portable computing device 100 may send and receive control signals to and from camera module subassembly 200a and modular lens accessory subassembly 500. These control signals may engage or disengage the operational state of camera input device 218, camera annunciator 220, image sensor 228, and/or illumination system 514.

As engaged by software operating on portable computing device 100 or by engagement of camera input device 218, images may then be captured and digitally converted (digitized) by image sensor 228. A continuous or intermittent stream of individually captured images over a given period of time may be considered a video stream, and may be transmitted in a similar fashion as individual images. Image(s) may then be transmitted via power/data cable 208 to portable computing device 100 to be displayed, saved, manipulated, and/or retransmitted to other computing devices by resident software applications.

### DETAILED DESCRIPTION—SECOND EMBODIMENT—FIGS. 1b, 2b, 3a, 4a, and 5a

A second embodiment of the modular peripheral digital camera system connectable to portable computing devices is illustrated in FIGS. 1b, 2b, 3a, and 4a.

The portable computing device 100, the external power supply 120, the camera module control system 222, the modular lens accessory subassembly 500, the lens unit 700, and all subcomponents of these four devices are defined as described as described for the first exemplary embodiment of the present disclosure referred to in FIGS. 1a, 2a, 3a, and 4a.

Additionally, but not shown in FIG. 3a, camera module control system 222 may be directly communicatively connected or coupled to other functional electronic components which may include the accessory receptacle 214, the wireless module 234, the battery pack 236, the DC power receptacle 206, the power controller 216, the camera input device 218, and the camera annunciator 220.

Referring to FIG. 1b, the portable computing device 100 may be communicatively connected or coupled to a wireless camera module subassembly 200b which may be removably physically coupled or attached to the modular lens accessory subassembly 500 which may in turn be removably physically coupled or attached to the lens unit 700. The external power supply 120 may also be communicatively (e.g., electrically) connected or coupled to the camera module subassembly 200b to provide continuous electrical power or battery charging capability as needed.

Referring to FIGS. 1b, and 2b, the wireless camera module subassembly is a device which may include power/data connector 202, power/data connector housing 204, DC power receptacle 206, a camera module housing 210, a camera module accessory adapter 212, and an accessory receptacle 214. Power controller 216 and DC power receptacle 206 may be connected or coupled directly to camera module control system 222, accessible through an opening in camera module housing 210.

A stream of electromagnetic waves 250 provide a communication link between the portable computing device 100 and the wireless camera module subassembly 200b. The electromagnetic waves are generated and received by the wireless communication module (e.g., radio, transceiver, transmitter, receiver and associated antenna(s)) contained within portable computing device 100 and the wireless module 234 contained within camera module subassembly 200a.

Operation of the second exemplary embodiment of the present disclosure may be the same as described for the first exemplary embodiment of the present disclosure referred to in FIGS. 1a, 2a, 3a, 4a, and 5a, given the following exceptions:

One may connect external power supply 120 to wireless camera module subassembly 200b by engaging DC power connector 122 into DC power receptacle 206. The battery pack 236 within wireless camera module subassembly 200b may be charged in the event that external power supply 120 is also connected to mains electrical power via power plug 128. Given a sufficient battery charge level of the battery pack 236, wireless camera module subassembly 200b will remain operational without connection of external power supply 120.

Upon initialization of an appropriate software application on portable computing device 100, the status of wireless camera module subassembly 200b and the connected modular lens accessory subassembly 500 may be determined via a communication link provided by the electromagnetic waves 250, facilitated by the wireless communication module contained within portable computing device 100 and the wireless module 234 contained within wireless camera module subassembly 200b. Further operational acts are as described for the first exemplary embodiment of the present disclosure in FIG. 5a.

### DETAILED DESCRIPTION—ALTERNATIVE EMBODIMENTS—FIGS. 1a-1d, 2a-2d, 3a-3d, 4a-4d, 5b, 6a-6b, 7a-7c, 8a-8c, and 9a-9c

There are various possible alternative embodiments of a modular peripheral digital camera system connectable to portable computing devices as illustrated in FIGS. 1a-1d, 2a-2d, 3a-3d, 4a-4d, and 5b

Referring to FIGS. 1c and 1d, the portable computing device 100 may be communicatively connected or coupled to the camera module subassembly 200a or to the wireless camera module subassembly 200b, either of which may be attached to a viewing instrument 800. As described for the previous exemplary embodiments of the present disclosure, the external power supply 120 may also be communicatively (e.g., electrically) connected or coupled to the camera module subassembly 200a or to the wireless camera module subassembly 200b to provide continuous electrical power or battery charging capability as needed.

The viewing instrument 800 may be a monocular microscope, a multi-ocular microscope, a monocular telescope, a multi-ocular telescope, a single-lens viewing scope, a compound-lens viewing scope, or other viewing instruments.

There are various additional possible alternative embodiments of a modular peripheral digital camera system connectable to portable computing devices as illustrated in FIGS. 1a-1d. These additional embodiments may include the use of camera module control system 222 configured as described in FIGS. 3b-3d.

Referring to FIG. 3b, the camera module control system 222 may be configured to include an image sensor SOC (System on Chip) 252 which may include the image sensor 228, an image frame buffer 254, and a serial interface 256. The image sensor SOC 252 may be a microelectronic integrated circuit housing at least one functional subcomponent including image sensor 228, image frame buffer 254, and serial interface 256.

The image frame buffer 254 may be at least one microelectronic subcomponent providing nontransitory electronic memory able to contain at least one frame of digitized image data. The image frame buffer 254 may be used to synchronize data transmission with connected functional components.

The serial interface 256 may be a single-direction or bi-directional communication physical interface. Additionally, the serial interface 256 may be a communication physical interface able to send one binary digit of information at a time.

The serial interface 256 may be used to transmit an image data stream 240 to complimentary DVP interface 238 which may reside within the control processor unit 242. Control processor unit 242 may deliver the image control signal stream 244 to image sensor SOC 252, and may pass the image data stream 240 through to system data interface 246 while also managing input/output data stream 248. The input/output data stream 248 receives command signals from, and transmits data to, portable computing device 100.

Referring to FIG. 3c, the camera module control system 222 may include the image sensor 228 which may use a DVP interface 238 to transmit the image data stream 240 to complementary DVP interface 238 that may reside within the control processor unit 242. To facilitate synchronization of data with system data interface 246, image data stream 240 may be passed via a parallel interface 258 to complementary parallel interface 258 residing on the image frame buffer 254. Image data stream 240 may be queued by image frame buffer 254 and passed back to control processor unit 242 via parallel interface 258. Control processor unit 242 may deliver the image control signal stream 244 to image sensor 228, and may pass the queued image data stream 240 through to system data interface 246 while also managing the input/output data stream 248.

The parallel interface 258 may be a bi-directional communication physical interface. Additionally, the parallel interface 258 may be a communication physical interface able to send more than one binary digit of information at a time.

Referring to FIG. 3d, the camera module control system 222 may include the image sensor 228 which may use a DVP interface 238 to transmit the image data stream 240 to complementary DVP interface 238 that may reside within one or more configurable logic processors 260 (e.g., microprocessor, digital signal processor, application specific integrated circuit, programmable gate array, programmed logic controller). To facilitate synchronization of data, image data stream 240 may be passed via a parallel interface 258 to complementary parallel interface 258 residing on the image frame buffer 254. Image data stream 240 may be queued by image frame buffer 254 and passed back to configurable logic processor 260 via parallel interface 258 to more effectively control the flow of image data stream 240. Configurable logic processor 260 may deliver the image control signal stream 244 to image sensor 228. Using another parallel interface 258, configurable logic processor 260 may pass the queued image data stream 240 to complementary parallel interface 258 which may reside on control processor unit 242. Control processor unit 242 may pass the queued image data stream 240 through to system data interface 246 while also managing the input/output data stream 248.

The configurable logic processor 260 may be a microelectronic integrated circuit (e.g., microprocessor, digital signal processor, application specific integrated circuit, programmable gate array, programmed logic controller) which may contain programmable logic components and may contain nontransitory nonvolatile electronic memory.

Additionally, but not shown in FIGS. 3b-3d, camera module control system 222 may be directly connected to other functional electronic components which may include the accessory receptacle 214, the wireless module 234, the battery pack 236, the DC power receptacle 206, the power/data cable 208, the power controller 216, the camera input device 218, and the camera annunciator 220.

There are various additional possible alternative embodiments of a modular peripheral digital camera system connectable to portable computing devices as illustrated in FIGS. 1a-1b, wherein the use of lens unit 700 may not be required. These additional embodiments may include the use of modular lens accessory subassembly 500 configured as described in FIGS. 4b-4d.

Referring to FIG. 4b, the modular lens accessory subassembly 500 may include the modular lens accessory socket 502, the modular lens accessory latch 504, the modular lens accessory housing 506, and the modular lens accessory connector 508 as described for the previous exemplary embodiments of the present disclosure in FIGS. 1a, 1b, and 4a. Additionally, the modular lens accessory subassembly 500 may include the alignment key 510, the lens accessory latch 504, the modular lens accessory control system 512 the illumination system 514, and the light guide 516 as described for the previous exemplary embodiments of the present disclosure in FIGS. 1a, 1b, and 4a.

A lens array 522 may be mounted in a fixed position within the modular lens accessory subassembly 500. The lens array 522 may be one or more axially-aligned optical lens for enlarging, reducing, focusing, or modifying the view of an optical image. Additionally, subcomponents of the lens array 522 may have may have coatings and/or semi-opaque additives which reflect, direct, and/or interrupt the transmission of certain wavelengths of light. The inclusion of the lens array 522 as part of modular lens accessory subassembly 500 may provide users with specialized functionality and/or additional advantages (e.g., small size, environmental resistance, ability to view into constrained areas, etc.).

Referring to FIG. 4c, the modular lens accessory subassembly 500 may include the modular lens accessory socket 502, the modular lens accessory latch 504, the modular lens accessory housing 506, and the modular lens accessory connector 508, the alignment key 510, the modular lens accessory control system 512, the illumination system 514, the light guide 516, and the lens array 522 as described for the previous exemplary embodiment of the present disclosure in FIGS. 1a, 1b, and 4b.

Additionally, lens array 522 may be mounted in a lens carrier 528 within the modular lens accessory subassembly 500. The lens carrier 528 may hold lens array 522 in axial alignment, and may also provide the ability to move lens array 522 or subcomponents of lens array 522 axially. A lens adjustment control 524 may be an electronically-operated and/or a manually-operated component or subassembly that operates a lens adjustment mechanism 526. The lens adjustment mechanism 526 may be an actuator driven by electronic and/or manual means, connected to lens carrier 528. Additionally, the lens adjustment control 524 and the lens adjustment mechanism 526 may be connected to modular lens accessory control system 512. Operation of lens adjustment control 524 with lens adjustment mechanism 526 to move lens carrier 528 and lens array 522 may allow users to enlarge, reduce, focus, or modify the view of an optical image; thus the inclusion of these components as part of modular lens accessory subassembly 500 may provide users with specialized functionality and/or additional advantages as described in the previous exemplary embodiment of the present disclosure.

Referring to FIG. 4d, the modular lens accessory subassembly 500 may include the modular lens accessory socket 502, the modular lens accessory latch 504, the modular lens accessory housing 506, and the modular lens accessory connector 508, the alignment key 510, the modular lens accessory control system 512, the lens mounting thread 518, and the lens mounting surface 520 as described for the previous exemplary embodiment of the present disclosure in FIGS. 1a, 1b, and 4a. This configuration may allow users to attach alignment and attachment of lens unit 700 without being constrained by the added size, weight, and power requirements of the additional components described in the previous exemplary embodiment of the present disclosure illustrated in FIG. 4a.

Referring to FIGS. 1c, 1d, 2a, 2b, 3a-3d, 4a-4d, and the flowchart in FIG. 5b, operation of the various possible alternative embodiments of the present disclosure may be as follows.

The camera module subassembly 200a or the wireless camera module subassembly 200b may be inserted into the eyepiece opening of viewing instrument 800.

Further operational acts of the various possible alternative embodiments of the present disclosure are as illustrated by the flowchart in FIG. 5b; these further operational acts have been described in the previous exemplary embodiments of the present disclosure illustrated in FIGS. 1a-1d, 2a-2d, 3a-3d, 4a-4d, and 5a.

Referring to FIGS. 6a-6c, the networked arrangement of the main client portable computing device 100 relative to slave client and/or viewing client portable computing devices 100 may allow the main client portable computing device 100 to control and/or communicate with other locally-connected devices. In one such exemplary embodiment, the main client portable computing device 100 may be able to simultaneously view the information and/or images displayed on slave client portable computing devices 100, (e.g., the images provided by connected devices camera module subassembly 200a or wireless camera module subassembly 200b, status of software running on slave client portable computing devices 100, etc.). The main client portable computing device 100 may also selectively capture information and/or images from any of slave client portable computing devices 100 and display the also selectively captured information and/or images to external display device 802 as well as redirect the same selectively captured information and/or images to slave client and/or viewing client portable computing devices 100.

Referring to FIGS. 7a-7c, the same networked arrangement of the main client portable computing device 100 relative to slave client and/or viewing client portable computing devices 100 may be the same as illustrated in the exemplary embodiments described previously and illustrated in FIGS. 6a-6c. Additionally, the connection to one or more server 810 and to one or more database 812 facilitated by the connection to one or more external network 808 may provide users access to remote software-based functionality not possible exclusively by using locally-provided software and devices. For example, remote software-based functionality may include the ability to remotely store, retrieve, share, control, and/or manipulate images and/or information with other users within local installation 814.

Referring to FIGS. 8a-8c and 9a-9c, the same networked arrangement of the main client portable computing device 100 relative to slave client and/or viewing client portable computing devices 100 may be the same as illustrated in the exemplary embodiments described previously and illustrated in FIGS. 6a-6c and 7a-7c. Additionally, the connection to one or slave or viewing client devices within one or more distant installation 816, via one or more external network 808, may provide users access to remote software-based functionality not possible exclusively by using locally-provided software and devices. For example, remote software-based functionality may include the ability to remotely store, retrieve, share, control, and/or manipulate images and/or information with other users and/or devices within local installation 814 as well as with other users and/or devices within one or more distant installation 816.

In other exemplary embodiments, accessory receptacle 214 may have the capability to connect, receive input from, or provide output to one or more input devices or output devices (e.g., sensors, actuators, control systems, annunciators, display devices, etc.).

In further exemplary embodiments, one or more input devices or output devices (e.g., sensors, actuators, control systems, annunciators, display devices, etc.) may be connected either in addition to or in place of an image sensor within camera module subassembly 200a or wireless camera module subassembly 200b.

The teachings of U.S. provisional patent application Ser. No. 61/639,622 filed Apr. 27, 2012 are incorporated herein in its entirety. The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A camera system to provide image data representative of an image of a target to a portable computing device to be presented by a display of the portable computing device, the portable computing device being a unitary structure physically separate from the camera system and selectively communicatively coupled thereto, the camera system comprising:
an image sensor that converts the image of the target into the image data;
a communications subsystem configured to send the image data to the portable computing system when communicatively coupled to the camera system;
a detachable coupler that physically couples the camera system to one or more accessory devices, the coupler protruding outwardly and having an alignment structure to physically engage a respective complementary alignment structure on the accessory devices and align the camera system therewith; and
a latch that detachably couples the camera to the accessory devices.

2. The camera system of claim 1, further comprising:
a control system communicatively coupled to the image sensor.

3. The camera system of claim 2, wherein the communications subsystem of the camera system includes at least one port configured to physically and communicatively coupled with at least one cable to provide a communications path for the image data and to provide a communications path to provide electrical power to the camera subsystem.

4. The camera system of claim 3, wherein the camera system includes the at least one cable, the at least one cable including a first connector sized and dimensioned to physically and electrically couple to a port on the portable computing device, a second connector sized and dimensioned to physically and electrically couple to an electrical receptacle, and a third connector sized and dimensioned to physically and electrically couple with the port of the camera system.

5. The camera system of claim 4, further comprising:
at least one power converter electrically coupled between at least the second and the third connectors.

6. The camera system of claim 1, further comprising:
at least one secondary battery cell electrically coupled to supply power at least to the image sensor.

7. The camera system of claim 1, further comprising:
an illumination subsystem having at least one illumination source operable to emit illumination therefrom.

8. The camera system of claim 1, further comprising:
a plurality of lenses interchangeably coupleable to a housing of the camera system.

9. The camera system of claim 1, further comprising:
a means for communicatively coupling to one or more input devices or output devices, which may be connected either in addition to or in place of the image sensor.

10. A camera system kit to provide image data representative of an image of a target to a portable computing device to be presented by a display of the portable computing device, the portable computing device being a unitary structure physically separate from the camera system and selectively communicatively coupled thereto, the camera system kit comprising:
a camera module subassembly; and
modular lens accessory subassembly, at least a portion of which has a complementary shape and dimension to complimentary mate with at least a portion of the camera module subassembly,
the camera module subassembly comprising:
a camera module housing,
an image sensor housed by the camera module housing, and
a camera module accessory adapter that extends from the camera module housing,
the modular lens accessory subassembly comprising:
a modular lens accessory housing;
a modular lens accessory socket formed by at least a portion of the modular lens accessory housing, the modular lens accessory socket sized and configured to mate with the camera module accessory adaptor; and
modular lens accessory latch operable to selectively removably fasten the camera module accessory adapter to the modular lens accessory socket.

11. The camera system kit of claim 10, further comprising:
a communications subsystem configured to send the image data to the portable computing system when communicatively coupled to the camera system kit;

12. The camera system kit of claim 11, wherein the communications subsystem of the camera system includes at least one port configured to physically and communicatively coupled with at least one cable to provide a communications path for the image data and to provide a communications path to provide electrical power to the camera subsystem.

13. The camera system kit of claim 12, wherein the camera system includes the at least one cable, the at least one cable including a first connector sized and dimensioned to physically and electrically couple to a port on the portable computing device, a second connector sized and dimensioned to physically and electrically couple to an electrical receptacle, and a third connector sized and dimensioned to physically and electrically couple with the port of the camera system.

14. The camera system kit of claim 13, further comprising:
at least one power converter electrically coupled between at least the second and the third connectors.

15. The camera system kit of claim 11 wherein the camera module subassembly further comprises:
a control system communicatively coupled to the communications subsystem.

16. The camera system kit of claim 15, further comprising:
an illumination subsystem having at least one illumination source operable to emit illumination therefrom.

17. The camera system kit of claim 16, further comprising:
at least one secondary battery cell electrically coupled to supply power at least to the image sensor.

18. The camera system kit of claim 10, further comprising:
a plurality of lenses interchangeably coupleable to a housing of the camera system.

19. The camera system kit of claim 10 wherein the camera module accessory adapter to physically engage a respective complementary alignment structure on each of a plurality of accessory devices and align the image sensor therewith.

20. The camera system kit of claim 19 wherein modular lens accessory latch is operable to selectively removably fasten the camera module accessory adapter to the respective complementary alignment structure on the accessory devices.
